(19) United States
(12) Patent Application Publication
(10) Pub. No.: US 2010/0064780 A1
(43) Pub. Date: Mar. 18, 2010

(54) Pressure Determination In Microfludic Systems

(76) Inventor: Howard A Stone, BROOKLINE, MA (US)

Correspondence Address: Harvard University & Medical School;c/o Wolf, Greenfield & Sacks, P.C., 600 Atlantic Avenue, Boston, MA, 02210-2206, US

(21) Appl. No.: 11/989,344

(22) PCT Filed: Jul. 27, 2006
(86) PCT No.: PCT/US2006/029442

§ 371 Date: Sep. 2, 2009

Related U.S. Application Data
(60) Provisional application No. 60/703,029, filed on Jul. 27, 2005.
(60) Provisional application No. 60/732,241, filed on Nov. 1, 2005.

(51) Int. Cl. G01L 7/18; G01N 7/00

(52) U.S. Cl. 73/61.78; 73/747

(57) ABSTRACT

Methods and apparatus for measuring changes in pressure in a fluidic system are described. In one aspect, an apparatus for measuring pressure as described herein includes a test channel (e.g., a first fluidic channel (120)) and a control channel (e.g., a second fluidic channel (125)) that join a measuring region (130) downstream of the test and control channels. In some embodiments, fluid flowing in the test and control channels can be laminar and form a stable fluid interface in the measuring region. A property of the fluid interface, such as the position of the fluid interface, e.g., relative to a width of the measuring region, may be measured, in some cases visually. In some embodiments, introduction of a component (e.g., a cell) into the test channel can cause a change in pressure drop in the test channel. This change in pressure drop can cause a deflection of the fluid interface. The amplitude of deflection of the fluid interface can be correlated with the change in pressure caused by the introduction of the component in the test channel. In some cases, changes in pressure can be associated with a characteristic (e.g., a mechanical property) of the component. Advantageously, changes in pressure can be measured dynamically and in real time.

### FIELD OF INVENTION

The present invention relates to methods and apparatus for measuring changes in pressure, and more specifically, to methods and apparatus for measuring changes in pressure in a fluidic system.

### BACKGROUND

Fluidic systems, including microfluidic systems, have found application in a variety of fields. These systems that typically involve controlled fluid flow through one or more microfluidic channels can provide unique platforms useful in both research and production. For instance, one class of systems can be used for analyzing very small amounts of samples and reagents on chemical “chips” that include very small fluid channels and small reaction/analysis chambers. Microfluidic systems are currently being developed for genetic analysis, clinical diagnostics, drug screening, and environmental monitoring. These systems can handle liquid or gas samples on a small scale, and are generally compatible with chip-based substrates. The behavior of fluid flow in these small-scale systems, therefore, is central to their development. Advances in the field that could, for example, enable the study of fluid motions at the micron- and/or nano-scale would find application in a number of different fields.

### SUMMARY OF THE INVENTION

The invention provides a series of methods associated with measuring changes in pressure, and related apparatus.

In one embodiment, a method of determining a characteristic associated with a mechanical property of a component is provided. The method comprises measuring a change in pressure drop in a fluid containing a component flowing in a fluidic channel, between a first position upstream of the component and a second position downstream of the component, at least two different points in time and/or at least two different positions of the component in the channel, respectively, and determining at least one characteristic associated with a mechanical property of the component from the measuring procedure.

In another embodiment, a method of determining a characteristic of a component is provided. The method comprises flowing a fluid containing a component in a fluidic channel, causing a first pressure drop between a first position and a second position in the channel at a first point in time and/or at a first location of the component in the channel, and measuring a change in the first pressure drop relative to a control, causing a second pressure drop, different from the first pressure drop, between the first position and the second position in the channel at a second point in time and/or at a second location of the component in the channel, and measuring a change in the second pressure drop relative to a control, and determining at least one characteristic of the component from the measuring procedure.

In another embodiment, a method of measuring a change in a pressure condition) in a fluidic channel characteristic of a sample component within a fluid in the channel is provided. The method comprises flowing a first fluid in a first fluidic channel and causing a first pressure drop between a first position in the first channel and a second position in the first channel in response to the flowing of the first fluid, and flowing the first fluid from an outlet of the first channel into a measuring region downstream of the outlet, flowing a second fluid in a second fluidic channel and causing a second pressure drop, which can be the same or different from the first pressure drop, between a first position in the second channel and a second position in the second channel in response to the flowing of the second fluid, and flowing the second fluid from an outlet of the second channel into the measuring region, forming at least one fluid interface including the first and second fluids in the measuring region, flowing the first fluid, containing a sample component, in the first fluidic channel and causing a component-affected pressure drop between the first position in the first channel, upstream of the component, and the second position in the first channel, downstream of the component, in response to the flowing of the first fluid, and flowing the first fluid from an outlet of the first channel into a measuring region downstream of the outlet, and determining a change in a characteristic associated with the fluid interface in the measuring region indicative of a characteristic of the component, wherein the second pressure drop is essentially the same during the flowing of the first fluid in the first fluidic channel to cause the first pressure drop, and during the flowing of the first fluid containing the sample component in the first fluidic channel to cause the component-affected pressure drop.

In another embodiment, a method of measuring a change in a pressure condition in a fluidic channel characteristic of a sample component within a fluid in the channel is provided. The method comprises flowing a first fluid in a first fluidic channel and causing a first pressure drop between a first position in the first channel and a second position in the first channel in response to the flowing of the first fluid, and flowing the first fluid from an outlet of the first channel into a measuring region downstream of the outlet, flowing a second fluid in a second fluidic channel and causing a second pressure drop, which can be the same or different from the first pressure drop, between a first position in the second channel and a second position in the second channel in response to the flowing of the second fluid, and flowing the second fluid from an outlet of the second channel into the measuring region, forming at least one fluid interface including the first and second fluids in the measuring region, flowing the first fluid, containing a sample component, in the first fluidic channel and causing a component-affected pressure drop between the first position in the first channel, upstream of the component, and the second position in the first channel, downstream of the component, in response to the flowing of the first fluid, and flowing the first fluid from an outlet of the first channel into a measuring region downstream of the outlet, determining a change in a characteristic associated with the fluid interface in the measuring region indicative of a characteristic of the component, and determining a different component-affected pressure drop in the first channel for at least two different positions of the component within the first channel indicative of a characteristic of the component.

In another embodiment, a method of measuring a change in a pressure condition in a fluidic channel characteristic of a sample component within a fluid in the channel is provided. The method comprises flowing a first fluid in a first fluidic channel and causing a first pressure drop between a first position in the first channel and a second position in the first channel in response to the flowing of the first fluid, and flowing the first fluid from an outlet of the first channel into a measuring region downstream of the outlet, flowing a second fluid in a second fluidic channel and causing a second pressure drop, which can be the same or different from the first pressure drop, between a first position in the second channel and a second position in the second channel in response to the flowing of the second fluid, and flowing the second fluid from an outlet of the second channel into the measuring region, forming at least one fluid interface including the first and second fluids in the measuring region, flowing the first fluid, containing a sample component, in the first fluidic channel and causing a component-affected pressure drop between the first position in the first channel, upstream of the component, and the second position in the first channel, downstream of the component, in response to the flowing of the first fluid, and flowing the first fluid from an outlet of the first channel into a measuring region downstream of the outlet, determining a change in a characteristic associated with the fluid interface in the measuring region indicative of a characteristic of the component, and determining a different component-affected pressure drop in the first channel for at least two different points in time, indicative of a characteristic of the component.

In another embodiment, a method of measuring a change in a pressure condition in a fluidic channel characteristic of a sample component within a fluid in the channel is provided. The method comprises flowing a first fluid in a first fluidic channel and causing a first pressure drop between a first position in the first channel and a second position in the first channel in response to the flowing of the first fluid, and flowing the first fluid from an outlet of the first channel into a measuring region downstream of the outlet, flowing a second fluid in a second fluidic channel and causing a second pressure drop, which can be the same or different from the first pressure drop, between a first position in the second channel and a second position in the second channel in response to the flowing of the second fluid, and flowing the second fluid from an outlet of the second channel into the measuring region, forming at least one fluid interface including the first and second fluids in the measuring region, flowing the first fluid, containing a sample component, in the first fluidic channel and causing a component-affected pressure drop between the first position in the first channel, upstream of the component, and the second position in the first channel, downstream of the component, in response to the flowing of the first fluid, and flowing the first fluid from an outlet of the first channel into a measuring region downstream of the outlet, determining a change in a characteristic associated with the fluid interface in the measuring region indicative of a characteristic of the component, and determining a component-affected pressure drop in the first channel for at least two different points in time, indicative of a characteristic of the component.

In another embodiment, a method of measuring a change in a pressure condition in a fluidic channel characteristic of a sample component within a fluid in the channel is provided. The method comprises flowing a first fluid in a first fluidic channel and causing a first pressure drop between a first position in the first channel and a second position in the first channel in response to the flowing of the first fluid, and flowing the first fluid from an outlet of the first channel into a measuring region downstream of the outlet, flowing a second fluid in a second fluidic channel and causing a second pressure drop, which can be the same or different from the first pressure drop, between a first position in the second channel and a second position in the second channel in response to the flowing of the second fluid, and flowing the second fluid from an outlet of the second channel into the measuring region, forming at least one fluid interface including the first and second fluids in the measuring region, flowing the first fluid, containing a sample component, in the first fluidic channel and causing a component-affected pressure drop between the first position in the first channel, upstream of the component, and the second position in the first channel, downstream of the component, in response to the flowing of to the first fluid, and flowing the first fluid from an outlet of the first channel into a measuring region downstream of the outlet, determining a change in a characteristic associated with the fluid interface in the measuring region indicative of a characteristic of the component, and determining a component-affected pressure drop in the first channel as a function of time, indicative of a characteristic of the component.

In another embodiment, a method of measuring a change in a pressure condition in a fluidic channel characteristic of a sample component within a fluid in the channel is provided. The method comprises flowing a first fluid in a first fluidic channel and causing a first pressure drop between a first position in the first channel and a second position in the first channel in response to the flowing of the first fluid, and flowing the first fluid from an outlet of the first channel into a measuring region downstream of the outlet, flowing a second fluid in a second fluidic channel and causing a second pressure drop, which can be the same or different from the first pressure drop, between a first position in the second channel and a second position in the second channel in response to the flowing of the second fluid, and flowing the second fluid from an outlet of the second channel into the measuring region, forming at least one fluid interface including the first and second fluids in the measuring region, flowing the first fluid, containing a sample component, in the first fluidic channel and causing a component-affected pressure drop between the first position in the first channel, upstream of the component, and the second position in the first channel, downstream of the component, in response to the flowing of the first fluid, and flowing the first fluid from an outlet of the first channel into a measuring region downstream of the outlet, determining a change in a characteristic associated with the fluid interface in the measuring region indicative of a characteristic of the component, and determining a component-affected pressure drop in the first channel for at least two different positions of the component in the channel, a first component position and a second component position, wherein, when the component is in the first position, no essentially identical component is in the second position, and when the component is in the second position, no essentially identical component is in the first position.

In another embodiment, an apparatus for measuring changes in pressure is provided. The apparatus comprises a first fluidic channel including an inlet portion, a middle portion, and an outlet portion, wherein the inlet portion has a cross-sectional dimension larger than a cross-sectional dimension of the middle portion, the cross-sectional dimension of the middle portion being of dimension to cause deformation of a component flowing from the inlet portion to the middle portion of the first fluidic channel, a second fluidic channel including an inlet portion and an outlet portion, a measuring region downstream of the outlet portions of the first and second channels, wherein the measuring region is constructed and arranged to form a fluid interface between a first and a second fluid exiting the outlets of the first and second channels, respectively, and a detection device constructed and arranged to detect a change in a characteristic of the fluid interface.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor, is every component of each embodiment of the invention shown where illustration is not necessary to allow those of ordinary skill in the art to understand the invention. In the figures:

FIG. 1A shows a fluidic device for measuring change in pressure, according to one embodiment of the invention;

FIG. 1B shows a close-up of a fluid interface of the device of FIG. 1A, according to another embodiment of the invention; the change in position of the fluid interface can be correlated with a change in pressure in the device;

FIG. 1C shows a plot of change in position of a fluid interface as a function of change in pressure at different flow rates using the device of FIG. 1A, according to another embodiment of the invention;

FIG. 1D shows results of change in position of fluid interface as a function of time when cells enter a fluidic channel, according to another embodiment of the invention;

FIGS. 2A-2H illustrate a sequence showing deformation of a red and a white blood cell in a fluidic channel, according to another embodiment of the invention;

FIG. 2I is a plot of the change in pressure as a function of time of the sequence shown in FIGS. 2A-2H, according to another embodiment of the invention;

FIG. 3 is a plot of the change in pressure for different conditions characterizing the state of red blood cells in a fluidic channel, according to another embodiment of the invention;

FIGS. 4A-4F illustrate a sequence showing hemolysis of a red blood cell passing through a narrow constriction of a fluidic channel, according to another embodiment of the invention;

FIG. 4G shows a plot of the change in pressure as a function of time of the sequence shown in FIGS. 4A-4F, according to another embodiment of the invention;

FIG. 5 shows a schematic diagram of a calculation geometry of a fluidic device for measuring change in pressure, according to another embodiment of the invention;

FIG. 6 shows results of a numerical calculation and a pseudo-analytical result, according to another embodiment of the invention; and

FIGS. 7A-7D show results of varying parameters in numerical modeling calculations, according to another embodiment of the invention.

### DETAILED DESCRIPTION

The present invention relates to methods and apparatus for measuring changes in pressure, and more specifically, to methods and apparatus for measuring changes in pressure in a fluidic system. In one aspect, an apparatus for measuring pressure as described herein includes a test channel (e.g., a first fluidic channel) and a control channel (e.g., a second fluidic channel) that join a measuring region downstream of the test and control channels. In some embodiments, fluid flowing in the test and control channels can be laminar and form a stable fluid interface in the measuring region. A property of the fluid interface, such as the position of the fluid interface, e.g., relative to a width of the measuring region, may be measured, in some cases visually. In some embodiments, introduction of a component (e.g., a cell) into the test channel can cause a change in pressure drop in the test channel. This change in pressure drop can cause a deflection of the fluid interface. The amplitude of deflection of the fluid interface can be correlated with the change in pressure caused by the introduction of the component in the test channel. In some cases, changes in pressure can be associated with a characteristic (e.g., a mechanical property) of the component. Advantageously, changes in pressure can be measured dynamically and in real time.

The methods and apparatuses of the present invention can be used in a broad range of applications, including measurements of dynamical processes or events that change the hydrodynamic resistance of fluidic channels. For instance, in one embodiment and as discussed in more detail below, the influence of drug-modified mechanical properties of a cell can be measured quantitatively. In another embodiment, deformation of cells, including cell lysis events, can be recorded simultaneously with the dynamical variations of pressure drop (e.g., as a function of time).

Although some embodiments described herein show measurements of pressure using channels having cross-sectional dimensions on the micron-scale (e.g., microfluidic channels), the methods and apparatuses can also be applied to smaller channel dimensions such as channels having cross-sectional dimensions on the nano-scale (e.g., nanofluidic channels).

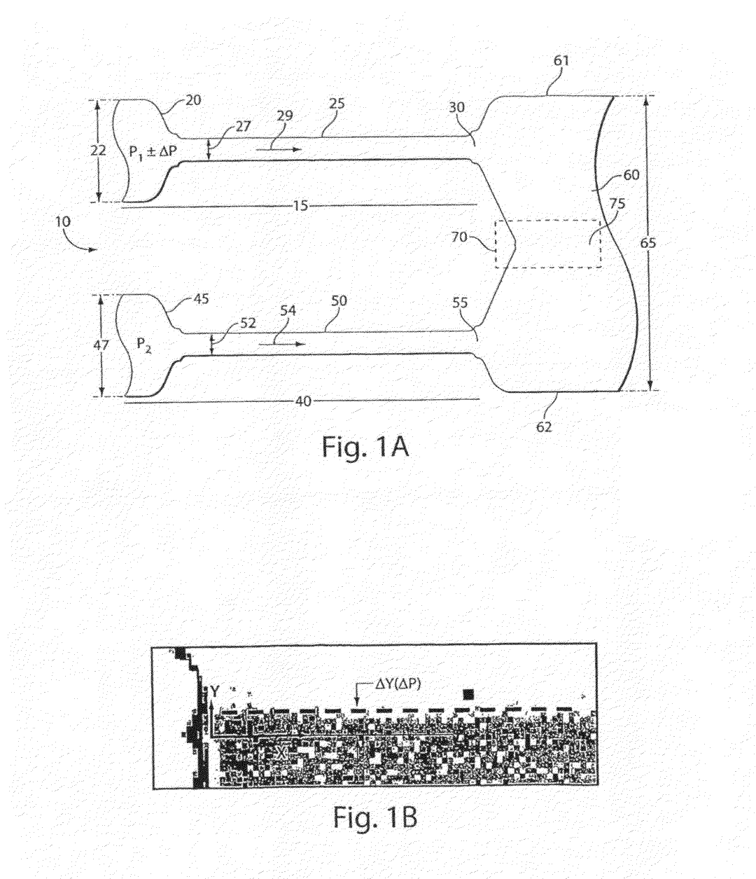

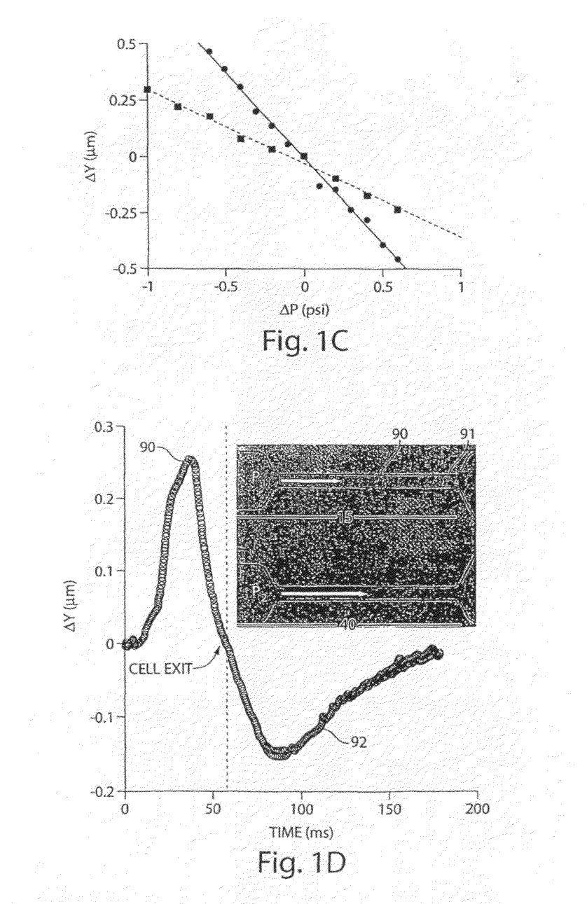

FIG. 1A illustrates a fluidic device 10 according to one embodiment of the invention. As shown in FIG. 1A, device 10 includes a first fluidic channel 15 having an inlet portion 20, middle portion 25, and outlet portion 30. Device 10 also includes a second fluidic channel 40 having an inlet portion 45, middle portion 50, and outlet portion 55. As illustrated in FIG. 1A, inlet portions 20 and 45 have widths 22 and 47 that are larger than widths 27 and 52 of middle portions 25 and 50, respectively. Advantages of this particular channel configuration are discussed in more detail below. It is to be understood that the structural arrangement illustrated in the figures and described herein is but one example, and that other structural arrangements can be selected. For instance, in some embodiments of the invention, dimensions of the inlet portions can be the same as, or larger than, dimensions of the middle portions of the channels.

Device 10 can also include measuring region 60, which can be fluidically connected to outlets 30 and 55 of channels 15 and 40, respectively. In some instances, measuring region 60 can include area 70, which may be, for instance, a region monitored by a detection device, and/or an area in which a detectable signal resides. As such, area 70 may be used to detect a characteristic associated with a fluid interface, e.g., fluid interface 75. A fluid interface can be any interface formed by two fluids, including liquids and gases, as discussed below. FIG. 1B shows a magnified view of area 70 within region 60. The fluid interface can be formed by the flow of a first fluid in channel 15 in the direction of arrow 29, and by the flow of a second fluid in channel 40 in the direction of arrow 54. As shown in FIG. 1A, area 70 and fluid interface 75 are positioned in the middle of measuring region 60 (i.e., it is centered between side walls 61 and 62 of the measuring region). In some particular embodiments, it may be desirable to position area 70 and/or fluid interface 75 in other regions of measuring region 60. The positioning of fluid interface 75 can be changed (e.g., dynamically) by changing the relative pressures of the fluid flows in channels 15 and 40.

In the embodiment illustrated in FIG. 1A, measuring region 60 has a width 65, which is larger than the combined widths of the most confined regions of channels 15 and 40, e.g., middle portions 25 and 50. This configuration can be useful for certain applications, such as for preventing a sample component flowing in channel 15 from exiting outlet 30 and interrupting fluid interface 75. For example, a large width of measuring region 60 may allow the sample component to flow across measuring region 60 without crossing a portion of fluid interface 75. In some cases, the sample component may cross a portion of fluid interface 75, but may not interrupt the portion of fluid interface in area 70 (e.g., the sample component may cross interface 75 downstream of area 70). In other cases, the sample component may cross a portion of fluid interface 75 within area 70, but may not disrupt the measurement of a signal in area 70. In other embodiments, width 65 of measuring region 60 can be smaller than the combined widths of inlet portions 20 and 45, and/or middle portions 25 and 50, such as when a small volume of device 10 is desired. Of course, a suitable width of measuring region 60 can vary depending on the size of channels 15 and 40, the size of the sample component, and/or flow rates of the fluids, etc.

In one embodiment, channel 15 can be used as a test channel and channel 40 can be used as a control channel for measuring a change in a characteristic associated with a fluid interface due to a change in pressure caused by introducing a sample component in the test channel. Initially, a first fluid can be flowed in the test channel and a second fluid can be flowed in the control channel. For instance, flow can be produced by pressurizing the first and second fluids in syringes connected to inlets of the fluidic device. This pressurization can cause a first pressure drop between a first position and second position in the test channel. Similarly, a second pressure drop between a first position and second position in the control channel can be formed. A stable fluid interface can be formed between the first and second fluids in the measuring region.

The first and second pressure drops (e.g., in the test and control channels, respectively) can be the same or different. In some instances, the first pressure drop can be measured relative to the second pressure drop. For instance, in the case of the first and second pressure drops being the same and in the absence of a component in the test and control channels, the difference between the first and second pressure drops can be zero, and can reflect a reference position of the fluid interface. In some cases, this measurement can be used as a reference point for determining changes in pressure drop in the test channel. In another example, a first and a second pressure drop may be different in the absence of a component in the test and control channels (e.g., the test and control channels may have different dimensions relative to one another). A first and a second fluid flowing in the test and control channels, respectively, may form a fluid interface downstream of channel exits, whose position in the measuring region can reflect a reference position. Therefore, even though the first and second pressure drops may be different, the position of the interface can be used as a reference point for determining changes in pressure drop in the test channel.

In some cases, introduction of a sample component in the test channel (e.g., in the first fluid) causes an increase in the first pressure drop in the test channel. This increase in pressure drop can be referred to as a “component-affected” pressure drop. This component-affected pressure drop can cause a change in a characteristic associated with the fluid interface (e.g., a change in the position of the interface relative to a reference position of the interface). This change in the characteristic associated with the fluid interface can be determined using various methods, as discussed in more detail below.

In some cases, the component-affected pressure drop occurs while the second pressure drop is maintained at a constant value (e.g., as a function of time). For instance, in one embodiment, the second pressure drop can be essentially the same during the flowing of the first fluid in the test channel and during flowing of the first fluid containing the sample component in the first fluidic channel that causes the component-affected pressure drop. In another embodiment, a component-affected pressure drop can be determined in the test channel for at least two different positions of the component within the test channel, and/or for at least two points in time. Measured values of the component-affected pressure drop for the at least two positions, and/or two points in time, can be the same or different, depending on the nature of the sample component, as discussed below. In yet another embodiment, a component-affected pressure drop can be determined in the test channel as a function of time. In another embodiment, a component-affected pressure drop can be determined in the first channel for at least two different positions of the component in the channel, a first component position and a second component position, wherein, when the component is in the first position, no essentially identical component is in the second position, and when the component is in the second position, no essentially identical component is in the first position.

The component-affected pressure drop can be, in some cases, indicative of a characteristic associated with sample component, such as a mechanical property (e.g., rigidity) of the sample component, as discussed in more detail below.

In some cases, a calibration of a characteristic associated with the fluid interface is required. For instance, if the characteristic of the fluid interface is the position of the interface, calibration of the deflection of the interface as a function of the pressure drop can be performed. Flow in the test and control channels (i.e., channels 15 and 40 of FIG. 1A) can be produced by pressurizing the fluids in syringes that are connected to two inlets of the fluidic device. With no sample components in the fluids, the pressure P₁ applied in the test channel and the pressure P₂ in the control channel can be fixed so that the fluid-fluid interface downstream is centered in the main exit channel, e.g., as shown in FIG. 1A. The pressure P₁ can be changed in small increments ΔP without changing the pressure P₂ in the control channel and the displacement of the interface can be followed in the Y direction, e.g., by performing image analysis with Matlab software (FIG. 1B). In one particular embodiment, the variation ΔY was linear in ΔP for the two initial working pressures applied, P₁=5 psi and P₁=10 psi (FIG. 1C). Also, the slope of ΔY (ΔP) at P₁=5 psi was twice as large as the slope at P₁=10 psi (in absolute value); both responses are expected for small variations of this viscously driven flow.

Device 10 can be used to determine how the flow of a sample component (e.g., red blood cells, RBCs) in a fluidic channel can influence the pressure drop in a test channel. For instance, after calibration of the interface deflection as a function of the change in pressure drop, a dilute suspension of RBCs was introduced into the device. Each time a cell (e.g., cell 90 and 91) entered test channel 15 (FIG. 1D Inset), a movie of the whole field of view was recorded, which can allow measurement of the position of the interface (FIG. 1B) and the visualization of deformation of the cell. Each event can be analyzed with a computer and/or computer program, e.g., Matlab software, to measure the dynamical variations of the interface position (e.g., the pressure drop) as a function of time and of the deformation of the cell. An example of the measured pressure-drop variations following the entry of a single cell into a channel and continuing until after the cell has exited the channel is shown in FIG. 1D. First bump 90 corresponds to the change in pressure drop caused by a single cell flowing in the test channel. Second bump 92 in FIG. 1D corresponds to the cell exiting the test channel and into the measuring region, near the fluid interface line. This caused direct disturbance of the position of the fluid interface, but does not have any physical significance in terms of the global pressure-drop variations. FIG. 1D also shows that in certain embodiments, the present invention enables measuring pressure drop variations in a fluidic channel in real-time and on a millisecond time-scale.

A sample component can include any suitable component that can be introduced into a fluid and flowed into at least a portion of a fluidic channel, and cause a measurable change in the hydrodynamic resistance of a portion of the channel relative to the flow of the fluid in that channel portion in the absence of the component. Sample components may have any suitable size, volume, shape, and/or configuration. For example, a sample component may have a cross-sectional dimension of less than or equal to about 1 mm, less than or equal to about 500 μm, less than or equal to about 250 μm, less than or equal to about 100 μm, less than or equal to about 50 μm, less than or equal to about 10 μm, less than or equal to about 5 μm, less than or equal to about 1 μm, less than or equal to about 0.1 μm, less than or equal to about 10 nm, or less than or equal to about 1 nm. Non-limiting examples of sample components include cells, vesicles, capsules, polymers, proteins, DNA, polypeptides, micelles, liposomes, molecules, drops, microfoams, crystals, and beads.

In some cases, a sample component is chosen based on the size of the fluidic channel, or, the size of the fluidic channel is chosen based on the size of the sample component. For instance, a ratio of a cross-sectional area of a channel portion to a cross-sectional area of the component can be greater than or equal to about 1:1, greater than or equal to about 2:1, greater than or equal to about 5:1, greater than or equal to about 10:1, greater than or equal to about 50:1, or greater than or equal to about 100:1. In some embodiments, a ratio of a cross-sectional area of a channel portion to a cross-sectional area of the component can be less than about 1:1. This situation may occur, for instance, and as described in more detail below, when a sample component is small enough to enter one portion of a channel (e.g., inlet portion 20 of FIG. 1A), but is large enough that it must deform in order to enter another portion of the channel (e.g., middle portion 25 of FIG. 1A). A ratio of a cross-sectional area of a channel portion to a cross-sectional area of the component can be less than about 1:2, less than about 1:5, less than about 1:10, less than about 1:50, or less than about 1:100. A suitable ratio may depend, for instance, on the deformability of the sample component.

Sample components can cause changes in hydrodynamic resistance in a channel by a variety of different methods. In one embodiment, a sample component causes hydrodynamic resistance at least in part by deformation of the component (e.g., the deformation of a cell as it passes through a narrow channel). Deformation of a sample component can include, for instance, changing the shape of the sample component (e.g., compressing or expanding the component relative to the component's natural shape), stretching all or portions of the component, and/or causing all or portions of the sample component to rupture. In another embodiment, a sample component causes hydrodynamic resistance at least in part by changing the viscosity of the fluid (e.g., by causing certain components in the fluid to cross-link, or aggregate, e.g., as a function of concentration of the component in the channel).

In one embodiment, flow of a sample component in a fluidic channel can cause a static change in pressure between a first and a second position in the channel. Therefore, the change in pressure as a function of time and/or as a function of position of the sample component in the channel may be constant (e.g., the component-affected pressure drop is static). Flow of a polymer solution can be one example, in some cases. The flow of a hard object such as a rigid bead is another example. For instance, the bead can flow in a channel (e.g., channel 15 of FIG. 1A) having a wide portion (inlet portion 25) and a narrow portion (middle portion 25) of the channel. If the first position is chosen to be at the beginning of middle portion 25 and the second position is chosen to be at the end of middle portion 25, then the change in pressure between the first and second positions may be constant as a function of time and/or position of the component while the component is flowing in middle portion 25. However, once the object exits this middle portion of the channel, the pressure drop can change.

In another embodiment, flow of a sample component in a fluidic channel can cause a dynamic change in pressure between a first and a second position in the channel. In this case, the change in pressure between the first and second positions changes dynamically as a function of time and/or as a function of position of the sample component in the channel (e.g., the component-affected pressure drop is dynamic). The flow of a soft object, e.g., a cell, confined in a channel is one example. If a soft object flows in a channel similar to channel 15 in FIG. 1A, depending on the relative sizes of the soft object and the channel, the soft object can deform while it flows in the channel. This deformation can cause a change in hydrodynamic resistance of the channel (and therefore a change in the pressure drop between the first and second positions) as a function of time and/or position of the object in the channel.

As discussed in more detail below, methods and apparatuses of the invention can be used to measure both static and dynamic changes in pressure in the presence and/or absence of a component flowing in a channel. For instance, in one embodiment, a method of use may include measuring a change in pressure drop in a fluid containing a component flowing in a fluidic channel, between a first position upstream of the component and a second position downstream of the component. Measuring may be performed in at least two different points in time and/or at least two different positions of the component in the channel, respectively. In some cases, a pressure drop may be measured relative to a control (e.g., relative to a constant pressure drop in a control channel). In one embodiment, changes in pressure drop are measured as a function of time, e.g., continuously. In some cases, measurements can be performed on a millisecond time-scale. In some instances, these measurements can be used to determine at least one characteristic associated with a mechanical property of the component.

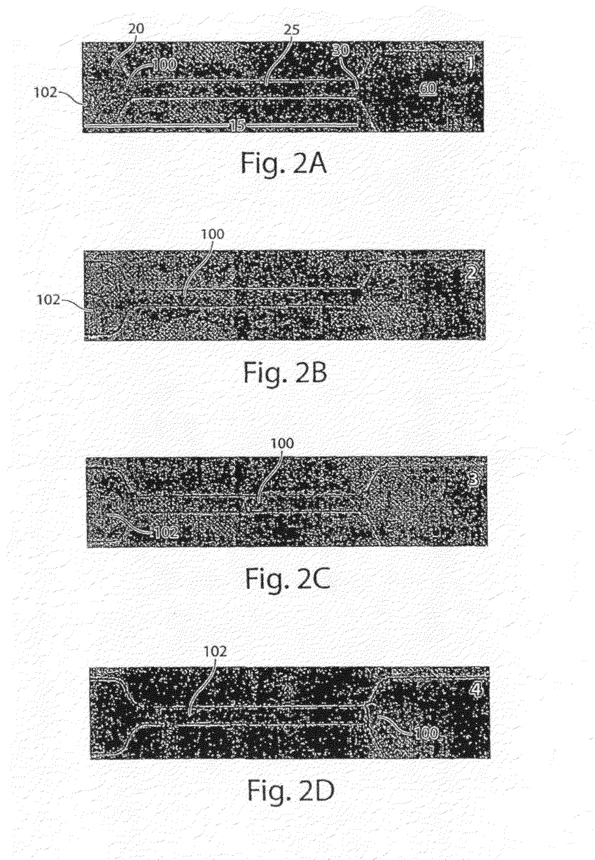

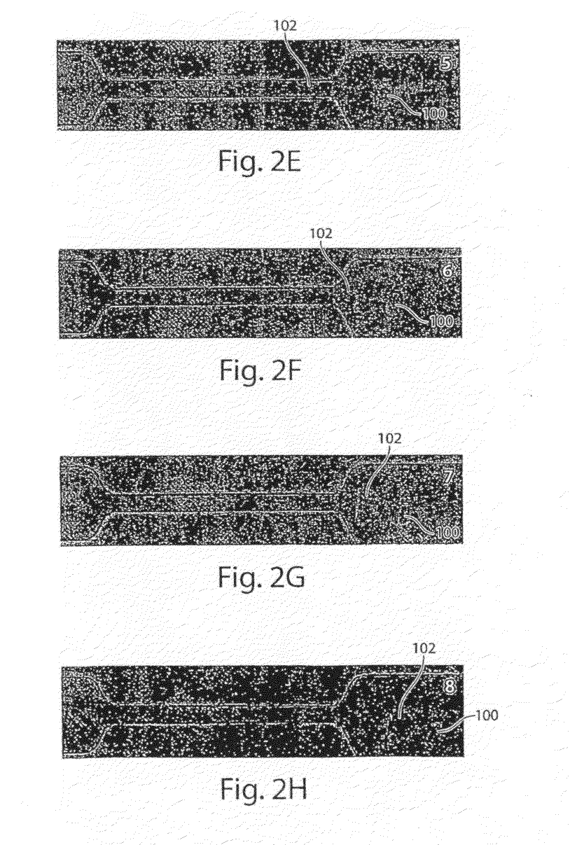

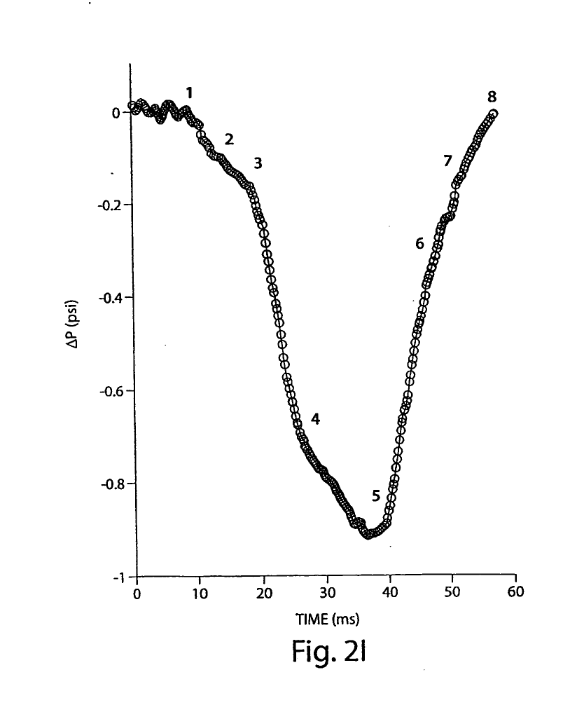

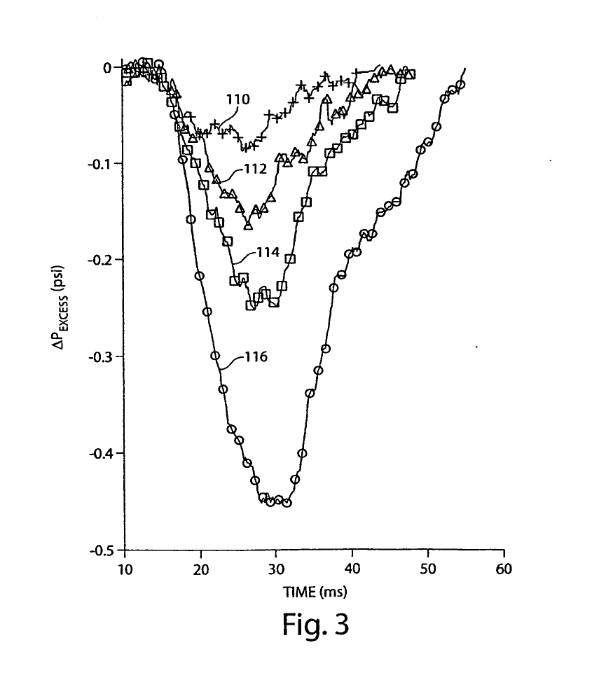

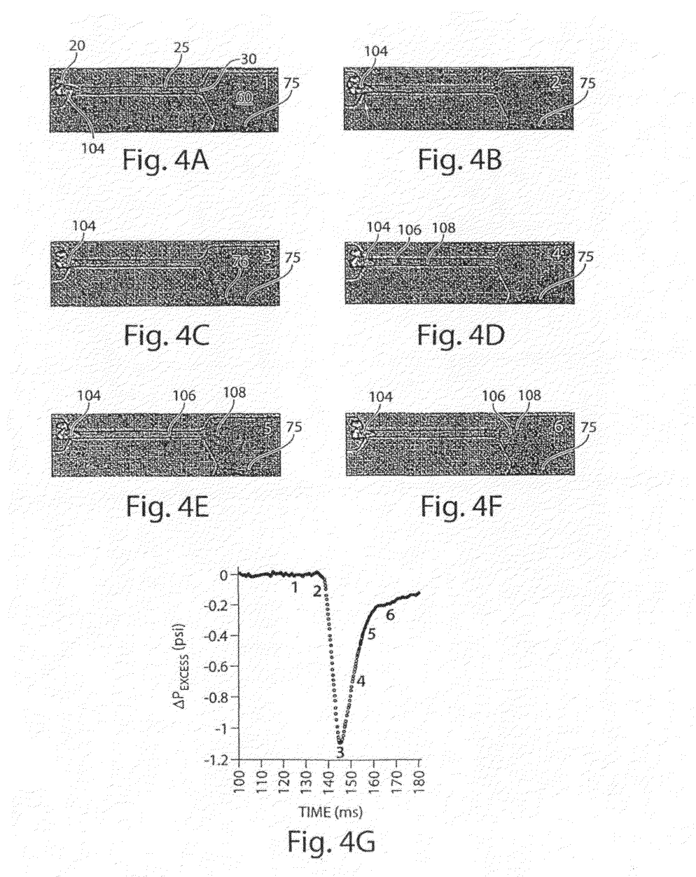

In some embodiments, device 10 can be used to measure the complete sequence of cell deformation, and the time evolution of the component-affected pressure drop while cells flow in a channel. This sequence is shown in FIGS. 2A-2H and in the plot in FIG. 21. As shown, a red blood cell 100 enters middle portion 25 of channel 15 followed shortly thereafter by a larger (and stiffer) white blood cell (WBC) 102. The time trace of the pressure drop variations (e.g., changes in the component-affected pressure drop) can be compared with the images of the sequence of deformations represented in the figure. The corresponding position and shape of the cells are represented on FIG. 21 by the numbering of the sequence. In one embodiment, the time evolution of the pressure drop while the same cell is in the channel, and away from either the entrance or exit, is a consequence of the deformation of the cell. This example illustrates the ability to monitor dynamically pressure drop and mechanical processes comparable to in vivo conditions occurring in the microcirculation.

In some cases, the differences between one component and another component can be determined by measuring the changes in pressure caused by the flow of each of the components in a channel. In certain embodiments, these changes in pressure can be indicative of a certain characteristic or state of the component (e.g., healthy vs. sick) and/or may suggest a change in a mechanical property between components (e.g., rigid vs. soft). In another embodiment, methods and apparatuses of the invention can be applied to screening the influence of a chemical and/or biological substance (e.g., a drug, toxin, hormone, and a gas) on a cell, e.g., by exposing the cell to that substance for various amounts of time. For example, the chemical and/or biological substance may cause a mechanical property in a cell to change, and an apparatus such as device 10 may be used to measure change in hydrodynamic resistance in a channel caused by the modification of the mechanical property of the cell. In other embodiments, the changes in pressure can indicate the number of components in the sample; for instance, device 10 may be used to count the number of cells in a sample, and/or to differentiate between one cell type and another. Other applications and/or methods of using the invention are also possible.

In one embodiment, a single healthy cell can be compared with a cell treated with a glutaraldehyde. Glutaraldehyde-treated cells are known to be stiffer than single healthy cells. FIG. 3 is a plot showing pressure drop versus time for different conditions characterizing the state of red blood cells at a driving pressure of 5 psi: line 110 (+symbols) represents a healthy RBC; lines 112, 114, and 116 (open symbols, Δ, □, and ∘) represent RBCs treated with 0.001% glutaraldehyde, line 112 (A symbols) represents 1 RBC, line 114 (□ symbols) represents a train of 2 RBCs, and line 116 (0 symbols) represents a train of 5 RBCs in middle portion 25 of channel 15. In the embodiment illustrated in FIG. 3, the pressure drop is enhanced following treatment with glutaraldehyde (e.g., comparing line 110 to 112) and the stationary shape of the cell is obtained at later times. These results show that methods and apparatuses of the present invention can allow differentiation of cells with different mechanical properties and/or geometrical features. Apparatuses such as device 10 may provide a simple biomedical tool for clinical hemorheology and pharmaceutical testing. The techniques described herein may aid in the understanding of how cell interaction and cell density in the microcirculation impact the overall pressure drop in a tissue.

As shown in FIG. 3, the pressure drop systematically increases as the number of cells increases but the results are not proportional to the number of cells. This qualitative response is typical of confined geometries with suspended particles spaced closer than the microchannel width.

In the embodiments illustrated in FIG. 1A and FIG. 4A, inlet portion 20 of channel 15 has a width larger than that the width of middle portion 25. In some embodiments, this channel configuration can be used to determine the pressure at which a sample component ruptures. A typical sample component that could be used in this determination may include, for instance, a sample component having a cross-sectional dimension larger than a cross-sectional dimension of middle portion 25, but having a cross-sectional dimension similar to or smaller than a cross-sectional dimension of inlet portion 20. For example, FIGS. 4A-4G illustrate the determination of the critical pressure at which the membrane of a red blood cell ruptures. In the embodiment illustrated in FIG. 4A, cell 104 blocks a portion of inlet 20, which leads to the entrance of middle portion 25 of channel 15. When the blockage event begins, the component-affected pressure drop increases linearly over less than 10 ms, and reaches a maximum value about 1.1 psi when hemolysis happens. This can be visualized by the rise of interface 75 compared to reference level 76 before rupture occurs (FIG. 4C). FIGS. 4D-4F show the subsequent hemolysis event in which the cell membrane ruptures. Ghost 106 of the RBC (FIGS. 4D-4F) can be visualized as well as hemoglobin solution 108, which follows the parabolic velocity distribution. This critical value of stress necessary for hemolysis is in good agreement with the approximate value 4000 Pa≈0.6 psi found with static micropipette experiment on pre-swollen RBCs.

Cells as a whole, or their components, may have different mechanical properties depending on various states of the cell; in some instances, these differences are indicative of a certain state of the organism. For instance, a malaria-infected RBCs has increased rigidity, which is associated with organ failure. Microfluidic approaches have been used recently to examine qualitatively the flow induced hemolysis (or “pitting”) of malaria-infected cells, and the methods and apparatuses of the present invention may provide a quantitative approach for more in-depth studies of these systems.

Applications of the methods and apparatuses of the present invention can include studies of the dynamics of “soft” objects such as, polymers (e.g. DNA), drops, microemulsions, microfoams, cells, vesicles and microcapsules. The interaction of the flow with these deformable entities is a tool to further investigate the details of their mechanical properties and their structural features, e.g., the entropic elasticity of a polymer, the viscoelastic properties of a capsule or the rheology of the liquid film between microbubbles in a foam. For the case of strong confinement offered by fluidic channels, the flow and shape of any close-fitting soft object is controlled by a competition between the objects' properties, the fluid pressure and the viscous stresses acting on the boundaries that resist the motion. The hydrodynamic resistance resulting from this fluid-structure interaction is reflected in a dynamical variation of the pressure drop along the channel during the flow and hence represents a crucial parameter that can be measured.

Different types of fluids can be flowed in the apparatuses of the invention. In one embodiment, a fluid in a test channel has an identical composition as the fluid in the control channel (e.g., during calibration of a device). In some instances, a fluid in the test channel is different from a fluid in the control channel. A variety of different types of fluids can be flowed in the test and control channels to form a fluid interface, including fluids that are miscible, immiscible, or partially miscible, and aqueous-based, oil-based, hydrophilic, or hydrophobic fluids. In some instances, one or more fluids may contain a dye (e.g., for visualization), or have a certain refractive index in order to distinguish one fluid from another and/or to form a detectable fluid interface.

Fluid may be flowed in a device by, for example, pushing or pulling the fluid through the a channel. Fluids can be pushed through the channel using, for example, a pump, syringe, pressurized vessel, or any other source of pressure. Alternatively, fluids can be pulled through a channel by application of vacuum or reduced pressure on a downstream side of the channel. Vacuum may be provided by any source capable of providing a lower pressure condition than exists upstream of the channel. Such sources may include vacuum pumps, venturis, syringes and evacuated containers.

A fluidic channel, as used herein, refers to a feature on or in an article (e.g., a substrate) that at least partially directs the flow of a fluid. The channel can have any cross-sectional shape (circular, oval, triangular, irregular, square or rectangular, or the like) and can be covered. In embodiments where it is completely covered, at least one portion of the channel can have a cross-section that is completely enclosed, or the entire channel may be completely enclosed along its entire length with the exception of its inlet(s) and outlet(s). A channel may also have an aspect ratio (length to average cross sectional dimension) of at least 2:1, more typically at least 3:1, 5:1, or 10:1 or more. The fluid within the channel may partially or completely fill the channel.

The channel may be of any size, for example, having a largest dimension perpendicular to fluid flow (e.g., cross-sectional dimension) of less than about 5 mm or 2 mm, or less than about 1 mm, or less than about 500 microns, less than about 200 microns, less than about 100 microns, less than about 60 microns, less than about 50 microns, less than about 40 microns, less than about 30 microns, less than about 25 microns, less than about 10 microns, less than about 3 microns, less than about 1 micron, less than about 300 nm, less than about 100 nm, less than about 30 nm, less than about 10 nm, or less than about 5 nm. In some cases the dimensions of the channel may be chosen such that fluid is able to freely flow through the article or substrate. The dimensions of the channel may also be chosen, for example, to allow a certain volumetric or linear flow rate of fluid in the channel. In another example, the dimensions of a channel may be chosen to allow a certain sample component in the channel.

The number of channels and the shape of the channels can be varied by any method known to those of ordinary skill in the art. In some cases, more than one channel or capillary may be used, e.g., two or more channels may be used, where they are positioned inside each other, positioned adjacent to each other, positioned to intersect with each other, etc. For example, in device 10, channels (such as channels 15 and 40 of FIG. 1A) can be arranged in any suitable orientation relative to one another. For instance, as shown in FIG. 1A, channels 15 and 40 are parallel to one another. In other embodiments, however, channels 15 and 40 can be arranged perpendicular, or add other angles (e.g., 30°, 70°, 100° relative to one another. Channels 15 and 40 may be designed to have the same or different shapes and/or volumes relative to one another. For instance, channel 15 and/or 40 can be straight, curved, and/or have both narrow and wide regions within the channel, in some embodiments.

A fluidic channel system, such as the one shown in FIG. 1A, may be fabricated by any method known to those of ordinary skill in the art. Examples include, but are not limited to, methods such as molding, embossing, rapid prototyping, etching, masking techniques, or combinations thereof. For example, a microfluidic channel system can be constructed according to the methods described in U.S. Pat. No. 6,719,868, which is hereby incorporated by reference in its entirety.

In one embodiment, a fluidic channel may be made by applying a standard molding article against an appropriate master. For example, microchannels can be made in PDMS by casting PDMS prepolymer (Sylgard 184, Dow Corning) onto a patterned photoresist surface relief (a master) generated by photolithography. The pattern of photoresist may comprise the channels having the desired dimensions. After curing for ˜2 h at 70° C., the polymer can be removed from the master to give a free-standing PDMS mold with microchannels embossed on its surface. Inlets and/or outlets can be cut out through the thickness of the PDMS slab. To form substantially enclosed microchannels, the microfluidic channels may be sealed in the following way. First, the PDMS mold and a flat slab of PDMS (or any other suitable material) can be placed in a plasma oxidation chamber and oxidized for 1 minute. The PDMS structure can then be placed on the PDMS slab with the surface relief in contact with the slab. The irreversible seal is a result of the formation of bridging siloxane bonds (Si—O—Si) between the two substrates) that result from a condensation reaction between silanol (SiOH) groups that are present at both surfaces after plasma oxidation.

Fluidic channels can be formed in a variety of different materials. In one embodiment, a fluidic channel is formed from a polymeric material. Suitable polymeric materials may have linear or branched backbones, and may have a high or low degree of crosslinking (or, alternatively, may be non-crosslinked), depending upon the particular polymer and the degree of formability desired of the material. A variety of polymeric materials are suitable for such fabrication, especially polymers of the general classes of silicone polymers, epoxy polymers, and acrylate polymers. Silicone elastomers include those formed from precursors including the chlorosilanes such as methylchlorosilanes, ethylchlorosilanes, and phenylchlorosilanes, and the like. A particularly preferred silicone elastomer is poly(dimethylsiloxane). Exemplary poly(dimethylsiloxane) polymers include those sold under the trademark Sylgard by the Dow Chemical to Company, Midland Mich., and particularly Sylgard 182, Sylgard 184, and Sylgard 186. Epoxy polymers are characterized by the presence of a three-member cyclic ether group commonly referred to as an epoxy group, 1, 2-epoxide, or oxirane. For example, diglycidyl ethers of bisphenol A may be used, in addition to compounds based on aromatic amine, triazine, and cycloaliphatic backbones. Another example includes the well-known Novolac polymers. In some embodiments, additives (e.g., hardening agents) may be added to a polymer in order to achieve a desired property (e.g., formability, hardness, etc.) of the material in which a fluidic channel is formed. Of course, fluidic channels can also be formed in non-polymeric materials such as glass, silicon, and quartz.

In one embodiment, a characteristic associated with a fluid interface (which may be correlated to a pressure or change in pressure) is determined. The characteristic may include position of the fluid interface (e.g., relative to a measuring region), such as the deflection of the interface from an initial position. In another embodiment, the characteristic may include the position of the fluid interface relative to the position of a sensor or another component of the device. A variety of determination techniques may be used. Determination techniques may include optically-based techniques such as light transmission, light absorbance, light scattering, light reflection and visual techniques. In one particular embodiment, a fluidic device can be mounted onto an inverted Leica microscope (DM IRB) coupled with a Leica 100× objective (NPlan) for bright field imaging (N.A.=1.25), e.g., to observe the motion of the fluids and/or sample components. A high-speed camera (Phantom V5) can be used to follow the motion (and/or the deformation of the components) through the channels. This system can allow an imaging rate of a few thousand frames per second. The field of view of the camera (1024×1024) can allow simultaneous observation of the sample components and the deflection of the fluid interface. In some embodiments, a computer and/or computer program such as Matlab can be used to calculate a quantitative value based on a change in a characteristic of the fluid interface. The computer and/or computer program may be in electrical communication with a detection device, e.g., to enable real-time analysis of samples.

The following examples are intended to illustrate certain embodiments of the present invention, but are not to be construed as limiting and do not exemplify the full scope of the invention.

### Example 1

This example shows the fabrication and operation of an apparatus for measuring changes in pressure according to methods of the present invention.

Apparatus 10 of FIG. 1A, was fabricated by the following procedure. A negative mask having a design of channels was placed on a silicon wafer that was spin-coated with a 5 μm thick layer of photoresist polymer (SU-8), and exposed to UV light. The cross-linked design was then developed to obtain a positive mold, and liquid poly(dimethylsiloxane) (PDMS) (Dow Corning) was poured over the mold. The PDMS was cured and peeled from the mold and two inlet holes were punched with custom-prepared 20G needles. The PDMS mold contained channels having the following features: inlet portions 20 and 45 had widths 22 and 47 of 25 μm, middle portions 25 and 50 had widths 27 and 52 of 5 μm, and measuring region 60 had a width 65 of 75 μm. All channels and channel regions had a height of 5 μm. The PDMS negative-mold was irreversibly bonded to a glass slide by oxidizing the mold and the glass side using an air plasma (˜2 ton) for 1 minute. The oxidized surfaces were brought together and sealed to produce the device.

For experiments with cells, a suspension of cells was loaded in a gas-tight syringe (Hamilton) and connected to a compressed air tank through custom adapters. PE 20 tubes were connected from the syringe needle to the inlet hole of the test channel of the device. A similar set-up was used with a dyed solution without the suspension and was connected to the inlet hole of the control channel of the device. Pressure applied to the needles was independently controlled by a regulator (Bellofram) with a precision of 0.001 psi. The fluid interface produced by the fluids in the test and control channels was visualized using an inverted Leica microscope (DM IRB) coupled with a Leica 100× objective (NPlan) for bright field imaging (N.A.=1.25). This setup also enable visualization of the motion of the fluids and cells in the apparatus. A high-speed camera (Phantom V5) was used to follow the motion (and/or the deformation) of the cells through the channels. The field of view of the camera (1024×1024) allowed simultaneous observation of the cells and the deflection of the fluid interface. Matlab was used to calculate quantitative values based on changes in deflection of the fluid interface.

### Example 2

This example shows the calculation of the maximum additional pressure drop, ΔP_{add}, (i.e., the component-affected pressure drop) during flow in a channel using measurements obtained from apparatus 10 of FIG. 1A.

Recent advances in computational mechanics have treated cell entry and translation in cylindrical geometries with models for the mechanical response of the cell. In one study, the red blood cell was treated as a viscous droplet surrounded by a thin elastic membrane of modulus Es. The dynamical response of these systems depends on the capillary number which is a dimensionless parameter Δ=μV₀/Es, where μ is the viscosity of the outer fluid and V₀ is the mean velocity of the fluid in the channel. For example, the maximum additional pressure drop ΔP_{add} during the flow was calculated to be ΔP_{add}=O(10-100)Es/Rt for 10₋₃<Δ<0.05, where Rt is the radius of the circular capillary. Using the measurements shown in FIG. 3, which were obtained using apparatus 10 of FIG. 1A, experimental results gave ΔP_{add}=9Es/Rt, which is in good agreement with the order of magnitude from the computational model. Finally, computational models providing ΔP_{add} as a function of the position along the channel and values obtained from experimental results were in qualitative agreement. A detailed comparison of simulation and experiment would require the same geometry and should in principle allow extraction of the mechanical properties.

This example shows that calculated values of maximum additional pressure drop, ΔP_{add}, using measurements obtained from a device of the invention are in good agreement with the values obtained from a computer model. This example also shows that measurements of maximum additional pressure drop obtained from the device are accurate.

### Example 3

This example shows a procedure that can be used to prepare samples for flowing into a device according to methods of the invention.

RBCs can be extracted from a droplet of blood obtained by pricking a finger of a healthy donor. The blood sample was diluted and washed twice with a solution of phosphate buffer saline (PBS) at an osmolarity of 300 mOs (physiological value). All the solutions were made with dextran of molecular weight of 2×10⁶ at a concentration of 9% w/w. The viscosity of the solutions was 47 cp. All the solutions were at pH 7.4.

In order to obtain rigidified RBCs, which allows characterization of the changes in pressure drop due to mechanical changes in the cell membrane, an extra step was added in the process of dilution. The RBCs were maintained in PBS solution containing a given concentration of glutaraldehyde (0.001% v/v to 0.01% v/v) at 25° C. for four minutes. The rigidified cells were then dispersed in the PBS solution with the same osmolarity, pH and viscosity as described previously. In the process of blood separation, a few white blood cells were separated with the RBCs allowing the study of their motion in the microchannels as well.

This example shows that samples can be prepared by following simple procedures for use in a device of the present invention.

### Example 4

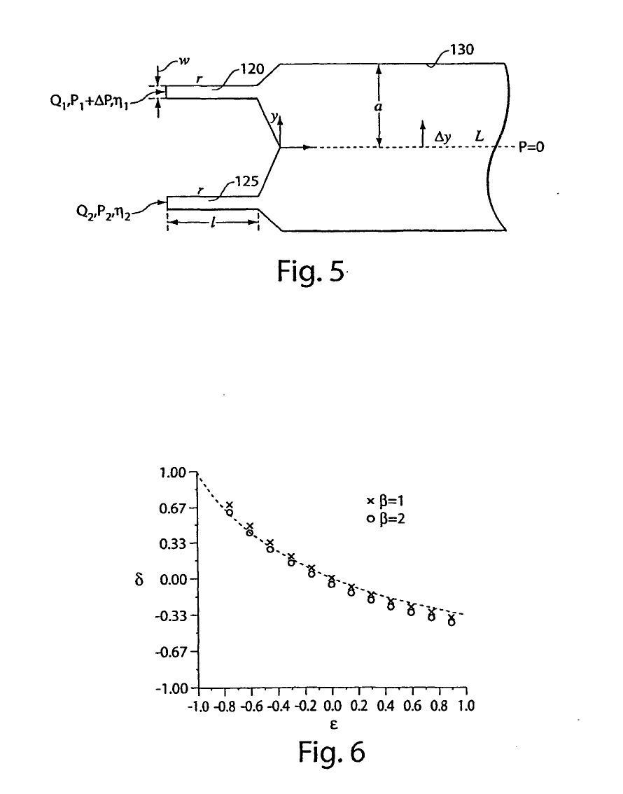

This example shows numerical calculations of fluid flow in a fluidic system as illustrated in FIG. 5.

FIG. 5 is a schematic diagram of a calculation geometry of a fluidic device for measuring change in pressure, as seen from above. The characteristic pressure, P₁, and the characteristic length scales, w, l, and a, and a coordinate system are defined. The following situation was considered: two fluids with density ρ and viscosities η₁ and η₂ are co-flowing in the channel. The height of the channel (in the z-direction) is w. The pressure difference between the two channel inlets is ΔP.

In the first part of the analysis, a simple approximation to derive the relationship between Δy and ΔP was applied.

FIG. 5 defines the parameters of this calculation. Upper inlet 120 contains a fluid with viscosity η₁ flowing with the volumetric flow rate Q₁ due to the pressure drop P₁+ΔP. The hydraulic resistance of the upper inlet tubing and inlet channel is R_{hyd}=r₁η₁, where r denotes the hydraulic resistance per viscosity, and thus is a purely geometrical parameter. Correspondingly, the fluid in lower inlet 125 has R_{hyd}=r₂η₂. It is expected that r₁≈r₂, but still, a difference is allowed, which could be due to tolerances in the channel fabrication or unmatched inlet tubings. After the two fluids enter wide common channel 130, they will start to co-flow due to the pressure P₃. It is expected that the main to pressure drop will be across the inlet channels, so that P₃/P₁<<1. At the end of the channel, P=0.

The following new variables are introduced: P₂=P₁(1+θ)ΔP=εP₁,P₃=φP₁,α=(r₂−r₁)r₁⁻¹, η₂/η₁==β, and δ=Δy/a.

Using a simple model of hydrodynamic resistances, the two flow rates in the two inlet channels can be calculated

Q₁=(P₁+ΔP−P₃)η₁⁻¹r₁⁻¹ (1a)

Q₂=(P₂−P₃)η₂⁻¹r₂⁻¹ (1b)

from which the following is obtained

$$\frac{{Q}_{1}}{{Q}_{2}} = ( 1 + α ) β \frac{1 + ɛ - φ}{1 + θ - φ} . \qquad ( 2 )$$

In the co-flow region, the following is obtained

$${P}_{3} \approx {Q}_{1} \frac{12 {η}_{1} L}{{w}^{3} ( a - Δ y )} \approx {Q}_{2} \frac{12 {η}_{2} L}{{w}^{3} ( a + Δ y )} , \qquad ( 3 )$$

where h is the height of the channel, and the hydraulic resistance of an infinitely wide channel has been used as an approximation to the real hydraulic resistance experienced by the co-flowing fluids. If the ratio Q₁/Q₂ is formed, the following i obtained

$$\frac{{Q}_{1}}{{Q}_{2}} = β \frac{1 - δ}{1 + δ} . \qquad ( 4 )$$

If Eqs. (2) and (4) are combined, β drops out, and the following result for δ is obtained

$$δ = {δ}_{0} + \frac{- ɛ ( 1 - α )}{\begin{matrix}2 + θ - 2 φ + ɛ - \\ α ( 1 + ɛ - φ )\end{matrix}} + \frac{θ + α ( 1 - φ )}{\begin{matrix}2 + θ - 2 φ + ɛ - \\ α ( 1 + ɛ - φ )\end{matrix}} , \qquad ( 5 )$$

where a finite initial displacement 60 has been inserted, which is present for P₁=P₂ and ΔP=0(θ=ε=0). This displacement may be due to different viscosities of the two fluids along with finite diffusion and/or imperfect fabrication.

Recall that the following is expected: |α|<<1 and φ<<1, and that θ=(P₂−P₁) P₁⁻¹ is adjusted such that δ=0 for ε=0, then the second term and δ₀ drop out, and Eq. (5) becomes

$$δ = \frac{- ɛ}{2 + θ + ɛ} \qquad ( 6 )$$

and thus for small values of ε, the following is obtained (re-inserted dimensional parameters)

$$\frac{Δ y}{a} = - \frac{Δ P}{{P}_{1} + {P}_{2}} \qquad ( 7 )$$

FIG. 6 shows the result of numerical calculations for θ=0 (crosses and circles) as described in below, along with the pseudo-analytical result found in Eq. (6) (dotted line). As shown, the pseudo-analytical result is in good agreement with the numerical results.

The following describes the numerical modeling of fluid flow in the device of FIG. 5.

Flow in the fluidic device has been analyzed by numerical calculations in Femlab 3.1. To do this, the Navier-Stokes equations for incompressible fluids coupled with the convection-diffusion equation was solved for the flow field v, the pressure field p, and the concentration, cε[0; 1], of the fluid that has viscosity η₂.

The characteristic variables are defined in FIG. 5, but for the numerics, P₁=P₂ was used. Non-dimensional variables were introduced as p=\tilde{p}P₁, ΔP=εP₁, x=\tilde{x}w³(al)⁻¹, v=\tilde{ν}P₁w³(η₀la)⁻¹, β=η₁/η₂, and finally \tilde{η}=η/η₀, where 2η₀⁻¹+η₂⁻¹.

With these scalings, the following set of equations remained

$$\begin{matrix}R ( \tilde{v} \cdot \tilde{∇} ) \tilde{v} = - \tilde{∇} \tilde{p} + ( \tilde{∇} \cdot ( \tilde{η} ( c ) \tilde{∇} ) ) \tilde{v} , & ( 8 a ) \\ \tilde{∇} \cdot \tilde{v} = 0 , & ( 8 b ) \\ P \tilde{v} \cdot \tilde{∇} c - {\tilde{∇}}^{2} c = 0 , & ( 8 c ) \\ \tilde{η} ( c ) = \frac{1 + β}{2 β} ( 1 - c + c β ) & ( 8 d )\end{matrix}$$

where the parameters of the model are the Reynolds number,

$$R = \frac{{ρ}_{m} {w}^{6} {P}_{1}}{{η}_{0}^{2} {l}^{2} {a}^{2}} , \qquad ( 9 a )$$

the Peclet number

$$P = \frac{{P}_{1} {w}^{6}}{D {η}_{0} {l}^{2} {a}^{2}} , \qquad ( 9 b )$$

β, and ε which enters through the boundary conditions. If the values characteristic of the experimental set-up are inserted, R≈6×10⁻⁷ and P≈0.2 is obtained, where a diffusion constant of D=3×10¹⁰ m²s⁻¹ has been used.

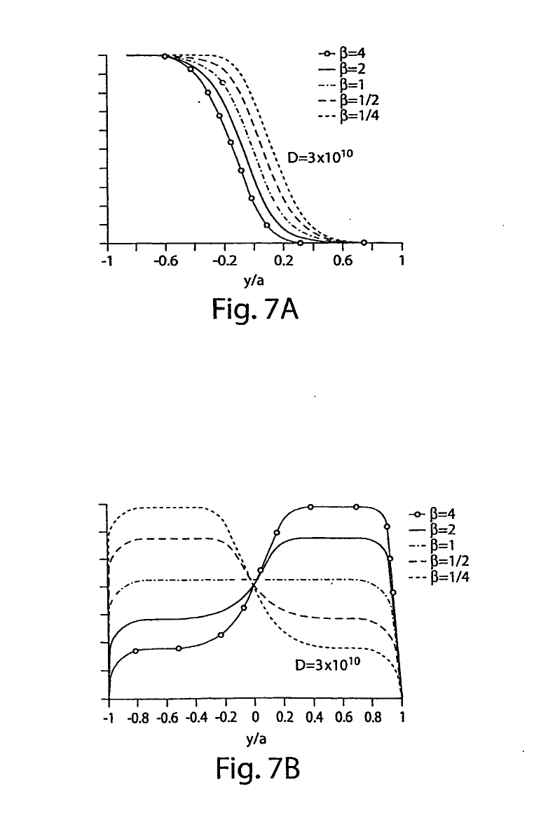

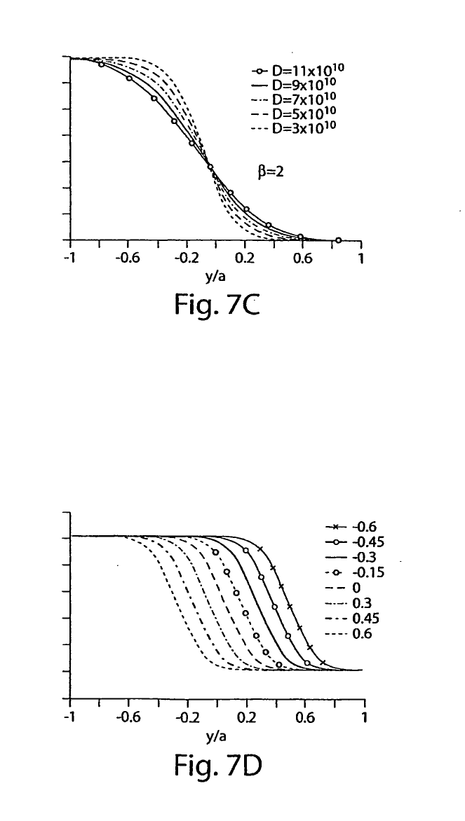

FIGS. 7A-7D show results of calculations where the different parameters in the model are varied. The Reynold's number was not varied since it is so low that a factor of a hundred in either direction will have no effect.

FIGS. 7A and 7B shows the change in the concentration profile and the velocity field, respectively, due to changes in β. It is seen from the velocity profile how the flow is still ‘centered’ around y/a=0, while the concentration profile is shifted. What is shifted is really the value of the concentration at y/a=0, so the shift is vertical rather than horizontal. This is further solidified by looking at FIG. 7C, which shows how the concentration profile changes with changes in the diffusion constant, which corresponds to changes in the Peclet number. In FIG. 7C, the Peclet number is changed for a constant value of β. It is seen that the value of the concentration at y/a=0 is unchanged, but the slope of the concentration profile is changed. When the diffusion constant is lowered, and thus the Peclet number is raised, the slope increases, and will be infinite for infinite Peclet number corresponding to a step function. The conclusion of this is that for finite Peclet numbers and β≠1, the position where c=½ is different from 0 for ε=0. However, this shift seems to be connected only to the shape of the fluid interface, and thus depends only on β and P not ε. FIG. 7D shows how the concentration profile changes with variations in ε. When only ε is varied, it can be seen that the fluid interface moves horizontally, but the shape of the fluid interface is unchanged as expected. In conclusion, finite P and β≠1 lead to a shift in the concentration profile, but this shift is independent of ε. This means that in the experimental situation, where a shifted concentration profile for ΔP=0 is cured by adjusting P₂, the changes, Δy, is related to ε only, not β and P.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases.

Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of”, when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. (canceled)

2. A method of determining a characteristic of a component, comprising:
flowing a first fluid containing a component in a fluidic channel;
causing a first pressure drop between a first position and a second position in the channel at a first point in time and/or at a first location of the component in the channel, and measuring a change in the first pressure drop relative to a control;
causing a second pressure drop, different from the first pressure drop, between the first position and the second position in the channel at a second point in time and/or at a second location of the component in the channel, and measuring a change in the second pressure drop relative to a control; and
determining at least one characteristic of the component from the measuring procedure.

3. A method of measuring a change in a pressure condition in a fluidic channel characteristic of a sample component within a fluid in the channel, comprising:
flowing a first fluid in a first fluidic channel and causing a first pressure drop between a first position in the first channel and a second position in the first channel in response to the flowing of the first fluid, and flowing the first fluid from an outlet of the first channel into a measuring region downstream of the outlet;
flowing a second fluid in a second fluidic channel and causing a second pressure drop, which can be the same or different from the first pressure drop, between a first position in the second channel and a second position in the second channel in response to the flowing of the second fluid, and flowing the second fluid from an outlet of the second channel into the measuring region;
forming at least one fluid interface including the first and second fluids in the measuring region;
flowing the first fluid, containing a sample component, in the first fluidic channel and causing a component-affected pressure drop between the first position in the first channel, upstream of the component, and the second position in the first channel, downstream of the component, in response to the flowing of the first fluid, and flowing the first fluid from an outlet of the first channel into a measuring region downstream of the outlet; and
determining a change in a characteristic associated with the fluid interface in the measuring region indicative of a characteristic of the component,
wherein the second pressure drop is essentially the same during the flowing of the first fluid in the first fluidic channel to cause the first pressure drop, and during the flowing of the first fluid containing the sample component in the first fluidic channel to cause the component-affected pressure drop.

4-8. (canceled)

9. A method as in claim 2, comprising measuring a change between the first pressure drop and the second pressure drop.

10. (canceled)

11. A method as in claim 2, comprising continuously measuring changes between the first pressure drop and the second pressure drop.

12. (canceled)

13. A method as in claim 11, wherein continuously measuring comprises measuring the changes on a millisecond time scale.

14. (canceled)

15. A method as in claim 2, wherein the second pressure drop is constant as a function of time.

16. A method as in claim 2, wherein the first position in the channel is an entrance to a narrow region of the channel and the second position in the channel is an exit to the narrow region of the channel.

17. A method as in claim 16, wherein the component at a first point in time and/or at a location in the channel is not positioned in the narrow region of the channel.

18. A method as in claim 16, wherein the component at a second point in time and/or at a second location in the channel is positioned in the narrow region of the channel.

19. A method as in claim 2, wherein the channel has a cross-sectional dimension of less than 50 microns.

20. A method as in claim 2, wherein the channel has a cross-sectional dimension of less than 10 microns.

21. A method as in claim 9, wherein measuring a change between the first and second pressure drops comprises measuring a characteristic associated with a fluid interface formed between the first fluid and a second fluid flowing in a second channel in fluid communication with the channel containing the first fluid.

22. A method as in claim 21, wherein measuring a change between the first and second pressure drops comprises measuring a deflection of the fluid interface.

23-24. (canceled)

25. A method as in claim 2, wherein the ratio of a cross-sectional area of the channel to a cross-sectional area of the component, while the component is positioned in the channel, is about 1:1.

26. A method as in claim 3, further comprising flowing the first fluid, containing a second sample component, in the first fluidic channel and causing a second component-affected pressure drop between the first position in the first channel, upstream of the component, and the second position in the first channel, downstream of the component, in response to the flowing of the first fluid, and flowing the first fluid from an outlet of the first channel into a measuring region downstream of the outlet.

27. (canceled)

28. A method as in claim 26, wherein the first component is a normal cell and the second component is a cell exposed to a chemical and/or biological substance.

29. A method as in claim 26, comprising comparing the second component-affected pressure drop with the first component-affected pressure drop.

30. A method as in claim 29, comprising determining a characteristic of the first and/or second component based on the comparing step.

31. (canceled)

32. A method as in claim claim 30, wherein the characteristic of the component is cell wall rigidity.

33. A method as in claim claim 29, comprising identifying the effect of a chemical and/or biological substance on the first and/or second component based on the comparing step.

34. An apparatus for measuring changes in pressure, comprising:
a first fluidic channel including an inlet portion, a middle portion, and an outlet portion, wherein the inlet portion has a cross-sectional dimension larger than a cross-sectional dimension of the middle portion, the cross-sectional dimension of the middle portion being of dimension to cause deformation of a component flowing from the inlet portion to the middle portion of the first fluidic channel;
a second fluidic channel including an inlet portion and an outlet portion;
a measuring region downstream of the outlet portions of the first and second channels, wherein the measuring region is constructed and arranged to form a fluid interface between a first and a second fluid exiting the outlets of the first and second channels, respectively; and
a detection device constructed and arranged to detect a change in a characteristic of the fluid interface.

35. An apparatus as in claim 34, further comprising a computer in electrical communication with the detection device constructed and arranged to generate a quantitative value based on the change in the characteristic of the fluid interface.
